(19) United States
(12) Patent Application Publication
(10) Pub. No.: US 2012/0311650 A1
(43) Pub. Date: Dec. 6, 2012

(54) IMAGE DISPLAY APPARATUS, INFORMATION TERMINAL APPARATUS AND METHOD OF DISPLAYING IMAGES

(75) Inventor: Toshiyuki Kito, Kodaira-shi (JP)

(73) Assignee: KABUSHIKI KAISHA TOSHIBA, Tokyo (JP)

(21) Appl. No.: 13/441,702

(22) Filed: Apr. 6, 2012

(30) Foreign Application Priority Data
May 31, 2011 (JP) 2011-122412

(51) Int. Cl. H04N 21/643

(52) U.S. Cl. 725/110

(57) ABSTRACT

According to one embodiment, an information terminal device including, a user interface unit configured to input an operating mode in which to activate an object apparatus, a command generation unit configured to refer to a list, thereby to generate a control command associated with the operating mode, and a transmission unit configured to transmit, to the object apparatus, the control command generated by the command generation unit.

### CROSS-REFERENCE TO RELATED APPLICATIONS

This application is based upon and claims the benefit of priority from prior Japanese Patent Application No. 2011-122412, filed May 31, 2011, the entire contents of which are incorporated herein by reference.

### FIELD

Embodiments described herein relate generally to an image display apparatus, an information terminal apparatus, and a method of displaying images.

### BACKGROUND

As digital broadcasting is more commonly used and as communication networks are provided in increasing numbers, any image display apparatus that receives digital broadcast programs can display not only the programs transmitted by electromagnetic waves, but also the programs and content the providers distribute through the networks. Now, many providers distribute much programming and content. More and more users therefore do not need to set the off-air TV broadcast reception mode as the initial operating mode in which their image display apparatuses start operating when activated.

Assume that a user, who does not want the off-air TV broadcast reception mode as the initial operating mode, inputs a desired operating mode when his or her image display apparatus is completely activated. Then, some time elapses until the display apparatus is switched to the desired operating mode.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of an activation system according to an embodiment;

FIG. 2 is an exemplary diagram showing an example of a communication apparatus (an information terminal apparatus) according to an embodiment;

FIG. 3 is an exemplary diagram showing an example of a receiving apparatus (television receiver) according to the embodiment;

FIG. 4 is an exemplary diagram showing an example of an activation signal according to the embodiment;

FIG. 5 is an exemplary diagram showing an example of an activation mode list according to the embodiment;

FIG. 6 is an exemplary flowchart explaining the operation of a transmitter according to the embodiment;

FIG. 7 is an exemplary flowchart explaining the operation of a television receiver (receiving apparatus) according to the embodiment;

FIG. 8 is an exemplary diagram showing an example of an activation signal according to an embodiment; and

FIG. 9 is an exemplary diagram showing an example of an activation signal according to another embodiment.

### DETAILED DESCRIPTION

Various embodiments will be described hereinafter with reference to the accompanying drawings. In general, according to one embodiment, an information terminal device comprising: a user interface unit configured to input an operating mode in which to activate an object apparatus; a command generation unit configured to refer to a list, thereby to generate a control command associated with the operating mode; and a transmission unit configured to transmit, to the object apparatus, the control command generated by the command generation unit.

Embodiments will now be described hereinafter in detail with reference to the accompanying drawings.

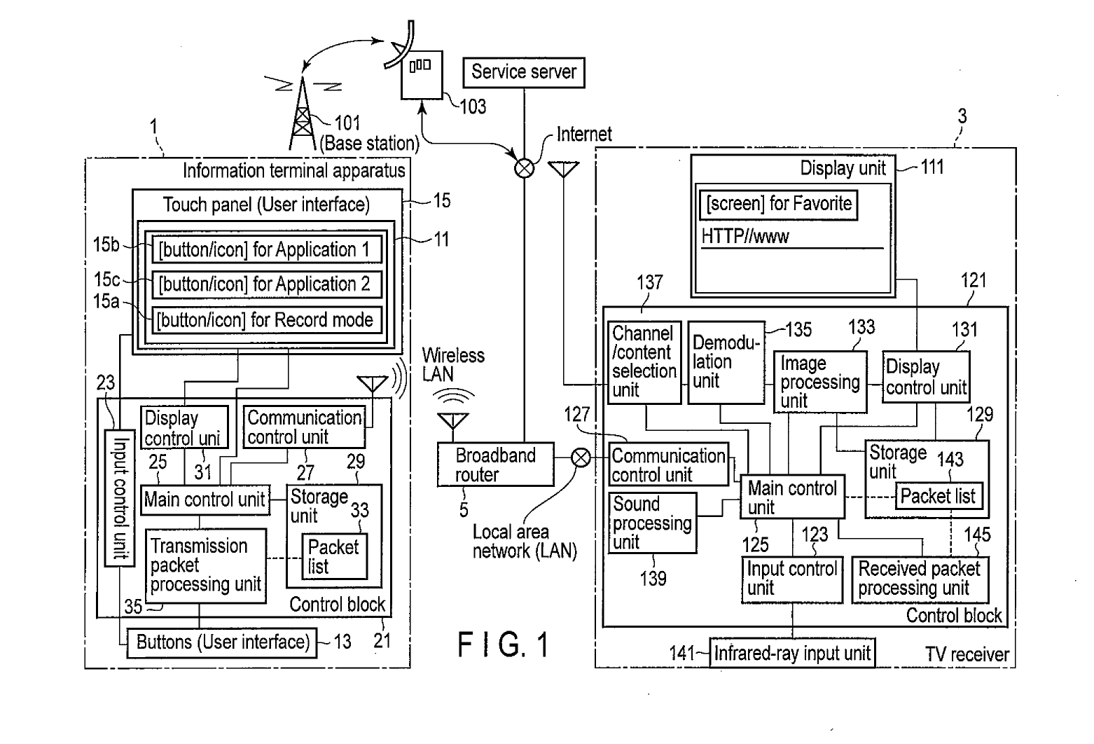

FIG. 1 shows an exemplary image processing apparatus according to an embodiment (e.g., image signal processing apparatus incorporated in, for example, a stereoscopic camera). The elements, components and functions, all described below, may be implemented by hardware or software for a microcomputer (i.e., processor or CPU).

The image display system shown in FIG. 1 includes an information terminal apparatus 1, a digital television receiver (hereinafter referred to as “TV receiver”) 3, and a broadband router 5. The information terminal apparatus 1 is a potable apparatus that a user may hold and operate. The TV receiver 3 is an image display apparatus. The broadband router 5 controls the connection of the information terminal apparatus 1 to the TV receiver 3, through a home local area network (LAN, i.e., closed network for communication within a household), or the connection of the information terminal apparatus 1 and TV receiver 3 to a service server provided outside the image display system, through the Internet.

The information terminal apparatus 1 includes a display unit 11, buttons 13, and a touch panel 15. The display unit 11 is configured to display content and input operating modes. The user may operate the buttons 13 and the touch panel 15 to input various data. At least one part of the touch panel 15 is integral with the display unit 11. The display unit 11 displays at least some of the buttons 13. Preferably, the buttons 13 and the touch panel 15 constitute a touch sensor unit, which detects that the user has touched displayed indicia such as button images and icons.

The information terminal apparatus 1 includes a control block 21. The control block 21 can be used to control each block that will be described below and to achieve communication with the broadband router 5.

The control block 21 includes an input control unit 23 and a storage unit 29, and a display control unit 31. The input control unit 23 receives input signals coming from the buttons 13 and touch panel 15. The storage unit 29 stores documents, images and various control data acquired in response to the user's instructions. The display control unit 31 controls the display unit 11, causing the same to display documents and images in desired sizes and at desired positions and to change the positions at which documents and image are displayed (to scroll the images), enabling the user to input data at the touch panel 15. The control block 21 further includes a main control unit 25, which controls the signal transfer and data acquisition between these units.

The control block 21 also includes a communication control unit 27. The communication control unit 27 operates under the control of the main control unit 25, accessing the home LAN by radio through the broadband router 5 and to the Internet through a radio communication network (data communication network) connected to a base station 101 and a communication company (carrier) 103.

Moreover, the control block 21 includes a packet list 33 and a transmission packet processing unit 35. The transmission packet processing unit 35 is configured to set an operating mode to the TV receiver 3 when the TV receiver 3 is activated. The transmission packet processing unit 35 refers to the packet list 33. The packet list 33 may be held in the storage unit 29.

The TV receiver 3 receives broadcast programs supplied in the form of aerial waves or the content distributed by a provider and then plays black the images and sound. The TV receiver 3 has a display unit 111 configured to display images, documents or Web pages.

The TV receiver 3 includes an input control unit 123, a main control unit 125, a communication control unit 127, a storage unit 129, a display control unit 131, an image processing unit 133, a demodulation unit 135, a station selection unit 137, a sound processing unit 139, a received packet processing unit 145, and a control block 121. The control block 121 controls the components 123, 125, 127, 129, 131, 133, 135, 137, 139 and 145.

The input control unit 123 receives a control input (control command) input at, for example, a remote controller (remote control terminal) through, for example, an infrared-ray input unit 141.

In response to the control command (control input) the input control unit 123 has received, the main control unit 125 outputs control signals for controlling the above-mentioned components.

The communication control unit 127 receives a control input coming via the broadband router 5 provided on the home LAN, for example, an Wake-on-LAN (WoL) packet supplied from, for example, the information terminal apparatus 1. The TV receiver 3 can therefore operate as an apparatus that is provided on the home LAN and should be controlled. Further, the communication control unit 127 is connected via the broadband router 5 to an external network (e.g., the Internet) and acquires (receives) programs distributed on demand or programs distributed via a network by providers using wired systems.

The storage unit 129, display control unit 131, image processing unit 133, demodulation unit 135, station selection unit 137 and sound processing unit 139, all provided in the TV receiver 3, are components of ordinary configurations, and are not described herein in detail. The demodulation unit 135 demodulates the program on the channel the station selection unit 137 has selected. From any program output from the demodulation unit 135, the image processing unit 133 and the sound processing unit 139 reproduce an image signal (also known as a “video signal”) and a sound signal (also known as an “audio signal”), respectively.

The image (video) signal the image processing unit 133 has reproduced is output to the display unit 111 (i.e. external image output terminal) through the display control unit 131.

The sound (audio) signal the sound processing unit 139 has reproduced is output to, for example, a speaker (i.e., external sound output (Aux) terminal).

The received packet processing unit 145 refers to an activation mode list 143. In accordance with the activation mode recorded in the activation mode list 143, the received packet processing unit 145 instructs the main control unit 125 to activate the TV receiver 3 in the activation mode designated by the WoL packet supplied via the communication control unit 127 from the information terminal apparatus 1. In other words, the main control unit 125 determines whether the received packet processing unit 145 has received an operation mode instruction from the information terminal apparatus 1 via the communication control unit 127 at the time of activating the TV receiver 3. If the received packet processing unit 145 has received the operation mode instruction, the TV receiver 3 is activated in the operating mode so designated.

In an embodiment, the information terminal apparatus 1 and the TV receiver 3 are connected by a local area network as described above. Nonetheless, the broadband router 5 has a radio LAN function. Therefore, the radio connection of the information terminal apparatus 1 and TV receiver 3 and the wired connection of the TV receiver 3 and the service server via the Internet can be switched, from one to the other.

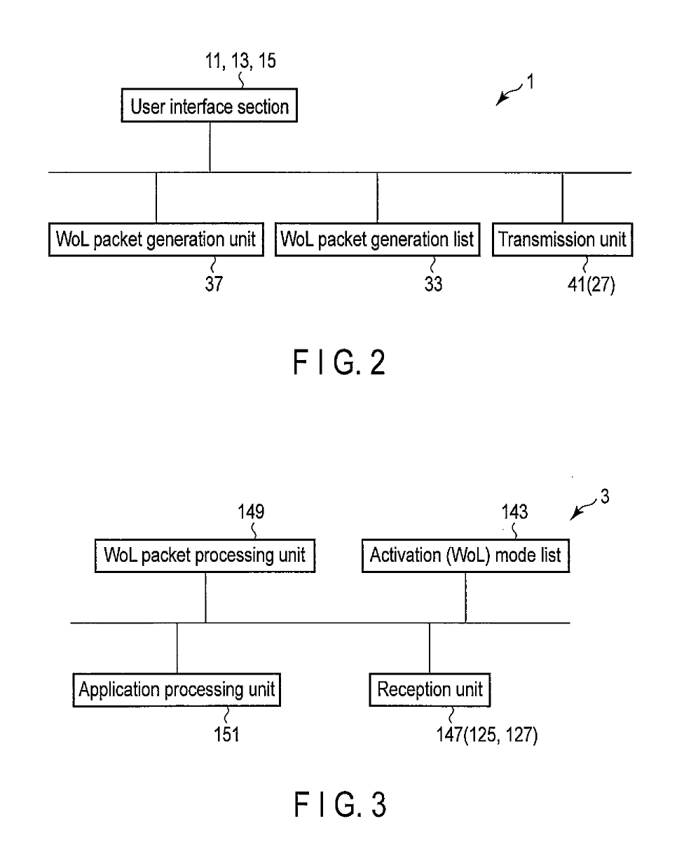

FIG. 2 shows the packet processing unit of the information terminal apparatus 1 and some components peripheral to the packet processing unit.

The display unit 11, the buttons 13, and the touch panel 15, all shown in FIG. 1, constitute a user interface unit. The user interface unit is connected by a control bus to an WoL packet generation unit 37 (equivalent to the transmission packet processing unit 35 shown in FIG. 2) and an WoL packet generation list 39 (equivalent to the packet list 33 shown in FIG. 1). The communication control unit 27 shown in FIG. 1 operates as transmission unit 41, under the control of the main control unit 25 shown in FIG. 1.

The touch panel 15 of the user interface unit can give the main control unit 25 a control command associated with the operating mode designated by the button or icon the user touches at the display unit 11. That is, the touch panel 15 can give the main control unit 25 the control command associated with the operating mode in which the TV receiver 3 should be activated.

The display unit 11 displays, for example, “Record Mode (15a in FIG. 1),” “Application 1 (15b in FIG. 1),” “Application 2 (15c in FIG. 1).” If “Record Mode” is selected, the information terminal apparatus 1 will be activated in “Record mode.” If “Application 1” is selected, the information terminal apparatus 1 will be connected to, for example, the Internet. If “Application 2” is selected, the information terminal apparatus 1 will be connected to, for example, a set-top box (STB, i.e., external tuner) configured to receive broadcast programs distributed by a specific provider, not programs broadcast by electromagnetic waves. “Record mode,” “Application 1” and “Application 2” may, of course, be replaced by logos or nicknames representing the objects to be activated.

When the user touches any icon or button the display unit 11 displays on the touch panel 15, thereby inputting a control command, the WoL packet generation list 39 is referred to, and the WoL packet generation unit 37 generates an WoL packet associated with the control command. The WoL packet is transmitted from the transmission unit 41.

FIG. 3 is an exemplary diagram showing the received packet processing unit 145 of the TV receiver 3 and some components peripheral to the received packet processing unit.

The packet processing unit 145 controls an WoL packet processing unit 149 that designates the operating mode (i.e., activation mode) defined by the WoL packet received via a reception unit 147 composed of the communication control unit 127 and main control unit 125, both shown in FIG. 1. The packet processing unit 145 also controls the operating mode the WoL packet processing unit 149 has designated by referring to the activation mode list 143. That is, when the TV receiver 3 is activated, the packet processing unit 145 also controls the display of an introduction screen of the “application” activated by an application processing unit 151 (and the activation of the application in the background). In practice, any operating mode that accords with the activation routine inherent to the TV receiver 3, such as the ordinary TV reception mode, is activated in the background, too.

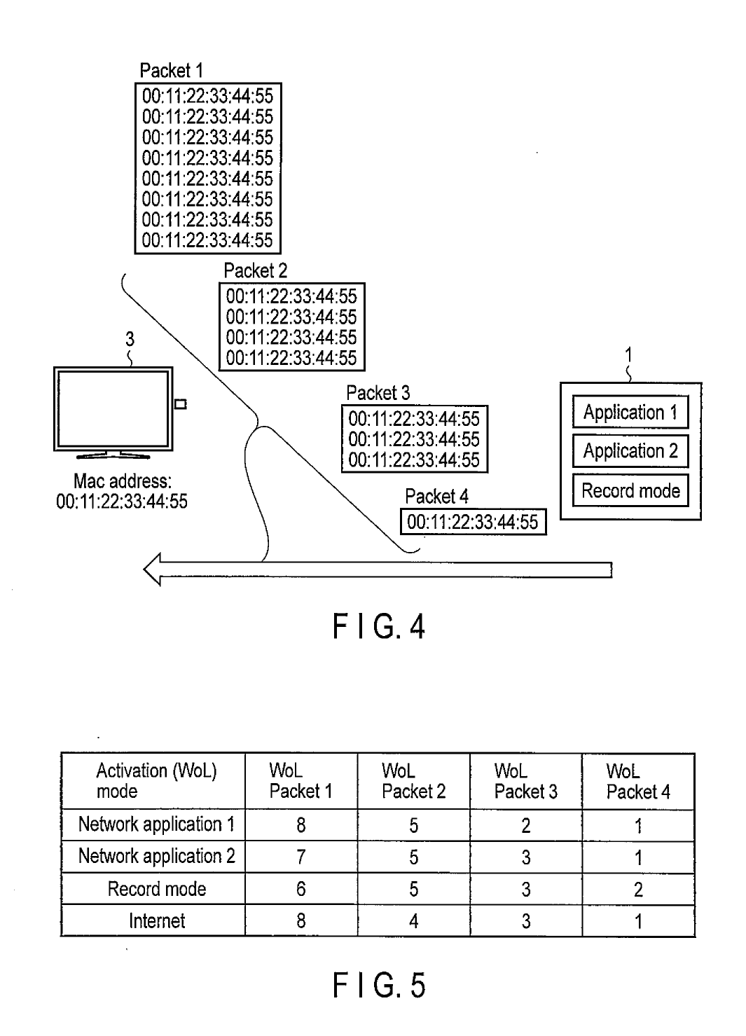

FIG. 4 shows a control command associated with the operating mode in which the TV receiver 3 should be activated as explained with reference to FIG. 2.

The WoL packet described above is one of the segments into which an Wake-on-LAN (an WoL) signal, i.e., an activation signal that turns on the main power supply, has been divided before the WoL signal is transmitted to any apparatus connected to the home LAN. Four WoL packets, for example, represent 16 media access control (MAC) addresses. A MAC address is, for example, “00, 11, 22, 23, 44, 55” that is data inherent to the TV receiver 3. As long as the TV receiver 3 remains on the LAN, the information terminal apparatus 1 can automatically acquire the MAC address.

Thus, four WoL signals of the existing type, or 16 MAC addresses, are transmitted to the TV receiver 3, turning on the power supply of the object (i.e., TV receiver 3) to be activated.

Assume that 16 MAC addresses are transmitted in the form of four groups (packets) to the TV receiver 3. Then, the TV receiver 3 can output an activation signal that identifies the aforementioned activation mode (i.e., application to activate at first) in accordance with the number of MAC addresses contained in each packet.

That is, if 16 MAC addresses are transmitted in the form of four packets, the TV receiver 3 will be set to the operating mode (application). In the ordinary operating mode, the TV receiver 3 is set when activated for the first time, in accordance with the combination of the MAC addresses contained in the four packets.

Assume that as shown in FIG. 4, the first (head) packet contains eight MAC addresses, the second packet contains four MAC addresses, the third packet contains three MAC addresses, and the fourth (last) packet contains one MAC address. Then, when the display unit 111 of the TV receiver 3 is turned on, it displays a browser screen (as shown in FIG. 1), enabling the user to connect the TV receiver 3 to the Internet. The TV receiver 3 can thus be set to an operating mode when it is activated.

FIG. 5 shows an exemplary activation mode list that shows various activation modes associated with four activation signals, respectively, each defined by four packets. Hence, each activation mode is defined by the number of MAC addresses contained in each of the four packets contains.

That is, a plurality of activation modes can be set, each by combining, as shown in FIG. 4, the numbers of MAC addresses the four packets contain, respectively.

The number of packets defining each activation mode is not limited to four. Each activation mode may be defined by, for example, six or eight packets, so long as the packets defining the activation mode contains 16 MAC addresses in total.

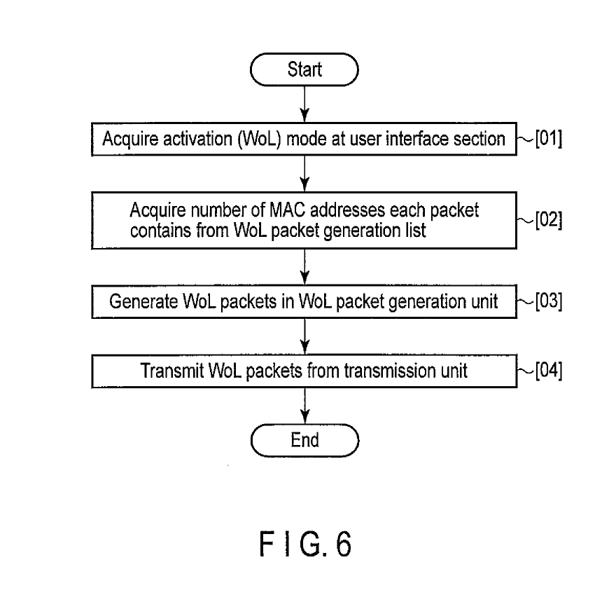

FIG. 6 is an exemplary flowchart explaining an exemplary method of transmitting the WoL packets from the information terminal apparatus 1.

First, the activation mode is selected at the user interface unit (i.e., display unit 11 or touch panel 15). The control command associated with the activation mode is input [01].

In response to the control command input, the number of packets and the number of MAC addresses each packet contains are acquired from the WoL packet generation list (i.e., packet list 33) [02].

In accordance with the number of packets acquired and the number of MAC addresses contained in each packet, the WoL packet generation unit 37 generates WoL packets [03].

The WoL packets generated are transmitted from the transmission unit 41 (i.e., communication control unit 27 and the antenna connected thereto) [04].

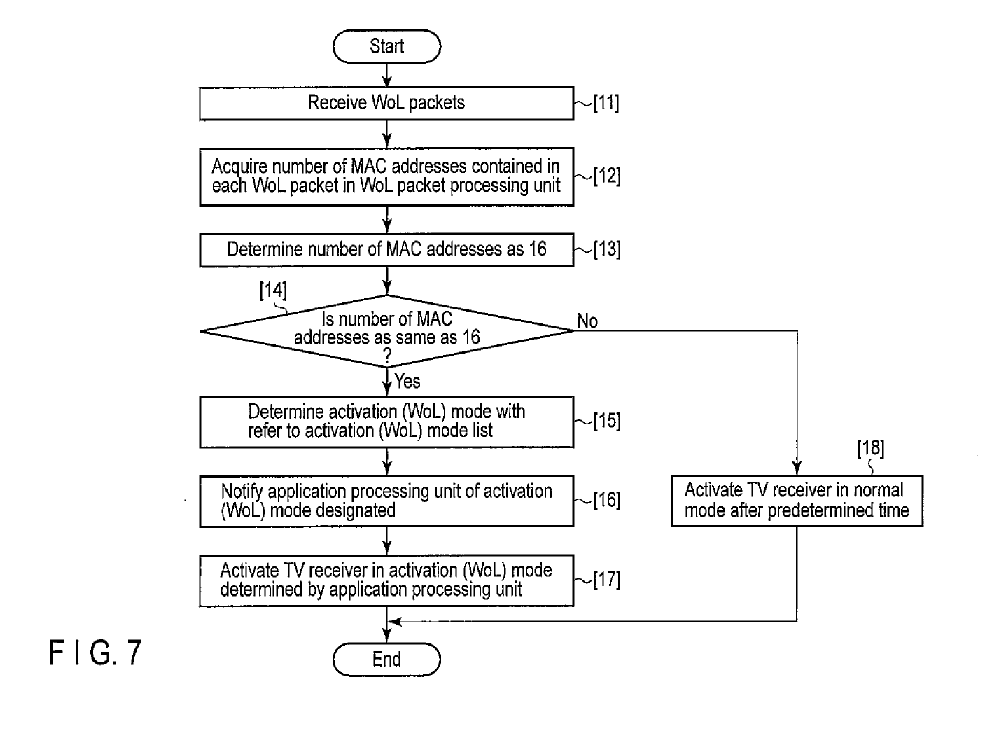

FIG. 7 shows how the TV receiver 3 operates after it has received WoL packets described above.

First, the reception unit 147 (communication control unit 127) receives the WoL packets [11].

Then, the WoL packet processing unit 149 acquires the number of MAC addresses contained in each WoL packet [12].

It is determined whether the number of MAC addresses, which the WoL packet processing unit 149 acquired, is 16 or not [13].

If 16 MAC addresses have been acquired [14-YES], the WoL packet processing unit 149 refers to the activation mode list 143, designating the activation mode [15].

The WoL packet processing unit 149 notifies the application processing unit 151 of the activation mode thus designated [16]. If no activation mode can be acquired from the activation mode list 143, the TV receiver 3 will be activated in the operating mode that accords with the activation routine inherent to the TV receiver 3.

Thereafter, the application processing unit 151 causes the display unit 111 to display the introduction screen of the “application” (and also activates the application in the background), in the activation mode selected at the user interface unit (i.e., display unit 11 or touch panel 15) [17].

If 16 MAC addresses cannot be acquired (that is, if less than 16 MAC addresses are acquired) (NO in [14]), the TV receiver 3 is activated in the operating mode that accords with the activation routine inherent to the TV receiver 3, upon lapse of a prescribed time [18]. In this case, the TV receiver 3 is activated in the ordinary mode that does not accord with the activation mode designated by the information terminal apparatus 1 (i.e., application that should be active at first). Nonetheless, the time elapsing until the display unit 111 displays a screen (image, etc.) can be prevented from increasing. At the time the TV receiver 3 is activated in the ordinary mode, the display unit 111 may display a message of, for example, “The operating mode the information terminal apparatus has designated cannot be recognized. To change the operating mode, please select a mode.”

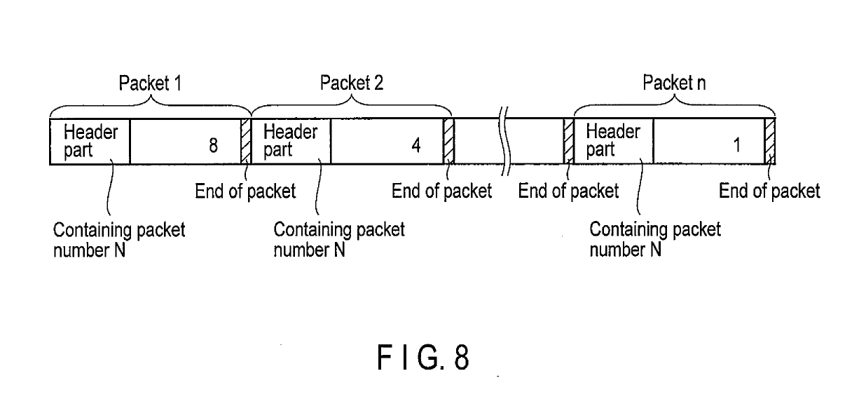

FIG. 8 shows an example of another type of a control command defined by the WoL packets 1 to n.

As shown in FIG. 8, the header part of each WoL packet may represent the “divided number n” (n denotes a number of divide of 16) of MAC addresses the WoL packet contains (that is, of 16 MAC addresses, how many are distributed to the WoL packet).

Since the head parts of packets 1 to n (n denotes the “divided number n”) within WoL, respectively, the time for determining whether 16 MAC addresses cannot be acquired (or whether less than 16 MAC addresses are acquired) can be shortened in the embodiment of FIG. 7.

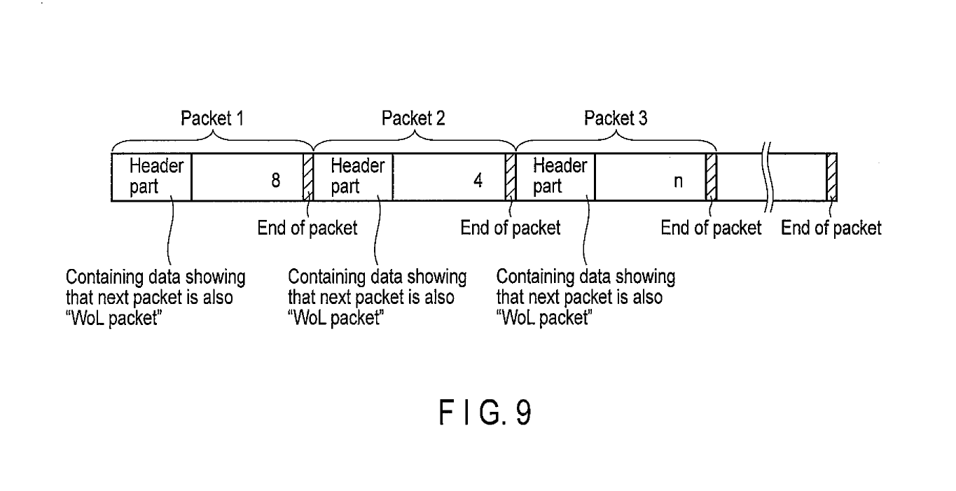

FIG. 9 shows still another type of a control command defined by the WoL packets described above.

As shown in FIG. 9, in the header parts of each WoL packet, excluding the last WoL packet, may hold “data representing the number of remaining WoL packets” or “data showing that the next packet is also an WoL packet.”

Since the header part of each WoL packet, excluding the last WoL packet, holds “data representing the number of remaining WoL packets” or “data showing that the next packet is also an WoL packet,” the TV receiver 3 can recognize that it has received an activation signal using WoL packets. Therefore, the time for determining whether 16 MAC addresses cannot be acquired (or whether less than 16 MAC addresses are acquired), because of reading errors or transmission errors, can be shortened in the embodiment.

The software/application that sets the TV receiver 3 to the operating mode by using the above-described WoL packets may be, for example, stored in the information terminal apparatus 1 or acquired (downloaded) from the service server. Alternatively, the software/application may be provided in the TV receiver 3 before the TV receiver 3 is put to sales. Still alternatively, the software/application may be updated (uploaded) when the TV receiver 3 is connected to the service server.

The image display apparatus is not limited to a TV receiver. Rather, it may be, for example, a personal computer (PC).

The information terminal apparatus 1 may be a portable personal computer (known as a “tablet PC”), a multi-function cellular telephone (called a “smartphone”), or a cellular telephone capable of displaying digital documents.

As has been described, the present embodiment can activate the application the user wants to use, in response to the command coming from the information terminal apparatus, as the image display apparatus (i.e., TV receiver) is activated.

Therefore, any application the user has designated can be activated within a short time in his or her image display apparatus (i.e., TV receiver), even if the image display apparatus holds many applications. Hence, the user feels the application he or she has designated is activated very fast.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information terminal apparatus comprising:
a user interface configured to receive input for an operating mode in which to activate an object apparatus;
a command generation unit configured to refer to a list to generate a control command associated with the operating mode; and
a transmission unit configured to transmit to the object apparatus the control command.

2. The information terminal apparatus of claim 1, wherein the control command comprises a number of packets comprising addresses inherent to the object apparatus.

3. The information terminal device of claim 2, wherein the control command comprises WoL packets for transmitting the addresses inherent to the object apparatus to turn on a power supply of the object apparatus.

4. An image display comprising:
a reception unit configured to acquire a number of packets in a control command and a number of addresses in each packet inherent to the image display;
a decision unit configured to determine an operating mode in which to activate the image display from the number of addresses in each packet inherent to the image display; and
an activating unit configured to activate the image display in the operating mode which the decision unit determined.

5. The image display of claim 4, further comprising:
a display unit configured to display the operating mode in which the activating unit activated the image display.

6. The information terminal device of claim 5, wherein the reception unit receives a number of addresses inherent to the image display apparatus in the form of a number of WoL packets.

7. A method of displaying images comprising:
acquiring, from a control command, a number of packets and a number of control data items in each packet;
determining an operating mode to be selected from the acquired packets and the addresses in each packet; and
outputting a display signal for displaying the determined operating mode.
